(19) United States
(12) Patent Application Publication
(10) Pub. No.: US 2010/0101338 A1
(43) Pub. Date: Apr. 29, 2010

(54) SAMPLING PIPE

(75) Inventors: YUAN-SHUN TSAI, Taoyuan County (TW); HSIU-WEI LEE, Taoyuan County (TW)

Correspondence Address: WPAT, PC;INTELLECTUAL PROPERTY ATTORNEYS, 7225 BEVERLY ST., ANNANDALE, VA, 22003, US

(73) Assignee: Institute of Nuclear Energy Research Atomic Energy Council, Executive Yuan, Taoyuan County (TW)

(21) Appl. No.: 12/260,236

(22) Filed: Oct. 29, 2008

(51) Int. Cl. G01N 1/20

(52) U.S. Cl. 73/863.52

(57) ABSTRACT

A sampling pipe suitable for sampling materials in a channel is disclosed. The sampling pipe includes a hollow body and a plurality of openings. The hollow body has a plurality of sampling sections, and these sampling sections are suitable for being disposed in the channel. The openings penetrate through the outer wall of the hollow body and locate in the sampling sections. Wherein, there is at least one opening in each sampling section, and flux of materials flowing into each sampling section is the same.

### FIELD OF THE INVENTION

The present invention relates to a sampling pipe, and more particularly, to a sampling pipe having a plurality of openings formed thereon in a manner that each opening is capable of allowing the same flux of materials to flow into the sampling pipe.

### BACKGROUND OF THE INVENTION

It is common for facilities like hospitals and laboratories to use radioactive materials. Therefore, for ensuring the safety of personals that are working regularly in such facilities, a certain radioactivity sampling and mocitoring must be performed in those facilities in a regular base so as to ensure the operations of such facilities meet with a radiation safety standard and regulation defined by relating nuclear regulatory authority. It is noted that one of such radioactivity sampling and mocitoring is a gas-sample analysis performed upon a gas sampled from a ventilation pipe by the use of a sampling pipe.

Please refer to FIG. 1, which shows a conventional sampling pipe. In FIG. 1, the sampling pipe 100 is a hollow tube with two open ends 102, 104. Operationally, the sampling pipe 100 is adapted for sampling gases from a ventilation pipe S by insetting its open end 102 into the ventilation pipe S while connecting another open end 104 to the piping of a inspection apparatus. Thereby, a portion of the gases flowing in the ventilation pipe S will be diverted to flow into sampling pipe 100 through the open end 102, and then, the gases flowing into the sampling pipe 100 through the open end 102 will be pumped to the inspection apparatus for radioactivity analysis.

However, as the sampling pipe 100, through the open end 102, can only sample the gas relating to the position in the ventilation pipe S where the open end 102 is located, the sampled gas may not represent all the flowing situations in the ventilation pipe S. In addition, as the flowing speed of the gas flowing in the center of the ventilation pipe S is faster than those flowing near the pipe wall, the radioactivity measured from the gases sampled at the center of the ventilation pipe S may be different from those sampled at a position near the pipe wall so that the measured radioactivity may be varied with the positioning of the open end 102. Therefore, the information acquired from the aforesaid conventional sampling pipe may not represent the whole truth of the actual situation in the ventilation pipe S.

Conventionally, the aforesaid problem is solved by insetting more than one such sampling pipes 100 in the ventilation pipe S while locating the corresponding open ends 102 at different positions in the ventilation pipe S. However, the insetting of more than one sampling pipe 100 into the pipe wall of the ventilation pipe S may adversely affect the airtightness of the ventilation pipe S. Therefore, it is suggested not to inset more than one sampling pipe 100, especially for those ventilation pipes having radioactive gases flowing therein.

### SUMMARY OF THE INVENTION

The primary object of the present invention is to provide a sampling pipe capable of accurately measuring the radioactivity in a working environment.

To achieve the above object, the present invention provides a sampling pipe suitable for sampling materials in a channel, which includes a hollow body and a plurality of openings. The hollow body has a plurality of sampling sections, and these sampling sections are suitable for being disposed in the channel. The openings penetrate through the outer wall of the hollow body and locate in the sampling sections. Wherein, there is at least one opening in each sampling section, and flux of materials flowing into each sampling section is the same.

In an exemplary embodiment of the present invention, each of the sampling section of the sampling pipe has one opening formed thereat while enabling the apertures of those openings at different sampling sections to be different from each other. For instance, the apertures of the openings formed on the sampling sections disposed at positions near the channel's wall are smaller than those away from the wall of the channel. In addition, the hollow body is configured with a marker for identifying whether the sampling pipe is disposed correctly for sampling the channel as soon as the marker is aligned with the wall of the channel, while the marker is located on the hollow body at a position thereof in a manner that, for any one opening of the sampling pipe, the distance between that opening and the marker divided by the aperture of that opening is a constant.

In an exemplary embodiment of the present invention, each of the sampling section of the sampling pipe has a plurality of openings formed thereat while enabling those openings formed on the same sampling section to have the same apertures. Moreover, the amount of the openings formed on the sampling sections disposed at positions near the wall of the channel are fewer than those away from the wall of the channel. In addition, a portion of the plural openings is sealed by a plurality of sealing parts.

In an exemplary embodiment of the invention, the sampling pipe is adapted for analyzing radioactive materials in a channel.

In an exemplary embodiment of the invention, the channel can be a ventilation pipe or a drain pipe.

To sum up, the sampling pipe of the invention is substantially a hollow tube configured with a plurality of sampling sections while each sample section is formed with at least an opening for allowing the flux of materials flowing into those sampling sections to be the same with each other, and thereby, the sampling pipe of the invention is capable of accurately measuring the amount of radioactive materials containing in a working environment.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows a conventional sampling pipe.

FIG. 2 shows a sampling pipe according to a first embodiment of the invention.

FIG. 3 shows a sampling pipe according to a second embodiment of the invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

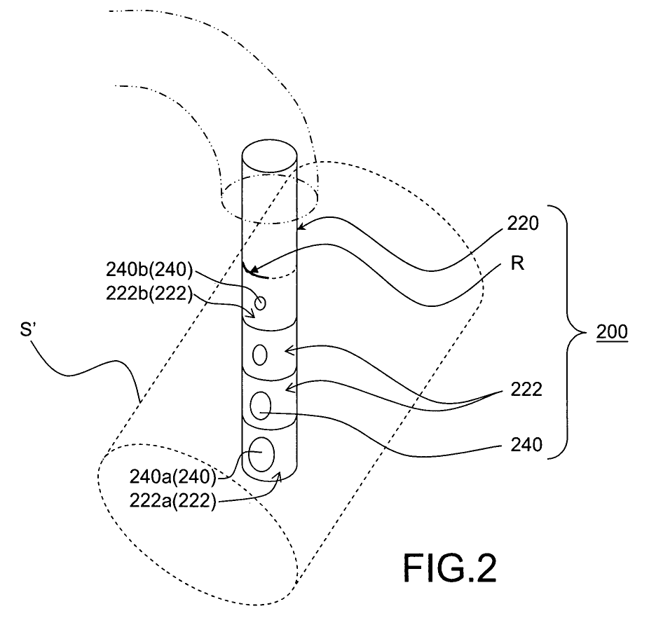

Please refer to FIG. 2, which shows a sampling pipe according to a first embodiment of the invention. The principle of the sampling pipe of the invention is to allow the flux of materials flowing into different sampling sections of the sampling pipe to be the same with each other. In FIG. 2, the sampling pipe 200 is adapted for sampling a material flowing in a channel S′. It is noted that the channel S′ can be a ventilation pipe or a drain pipe. In this embodiment, the material flowing in the channel S′ is a gaseous material and the sampling pipe 200 is adapted for analyzing radioactive materials in a channel S′.

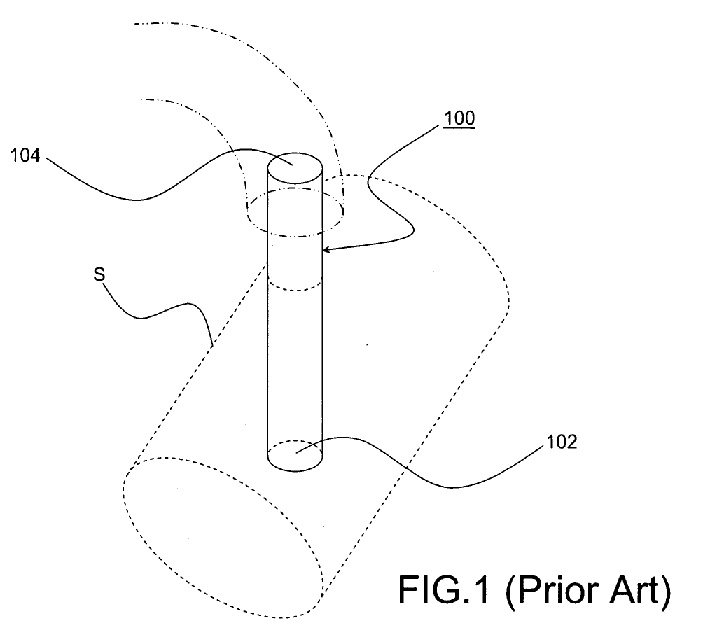

In detail, the sampling pipe 200 of the present embodiment includes a hollow body 220 and a plurality of openings 240, in which one end of the hollow body 220 is formed as a close end that is the potion for insetting into the channel S′, while the other end is formed as an open end, similar to the open end 104 shown in FIG. 1, that is the portion for connecting to the piping of a pump. The hollow body can be made of copper, aluminum, acrylic or other materials. In this embodiment, the hollow body 220 is configured with a plurality of sampling sections 222, and the openings 240 are formed penetrating through the outer wall of the hollow body 220 and are disposed on the sampling sections. As shown in FIG. 2, each sample section 222 is formed with at least one of the plural openings 240 and the same time that it is adapted to be disposed inside the channel S′. In the embodiment shown in FIG. 2, there are only four sampling sections 222 in the sampling pipe 200, but it is not limited thereby.

There is one opening 240 formed in each sampling section 222 of the sampling pipe 200, and the apertures of the openings 222 formed on different sampling sections 220 are different from each other. Moreover, the apertures of the openings 222 formed on the sampling sections 220 disposed at positions near the channel's wall are smaller than those away from the wall of the channel S′, in that as the sampling section 222a is the sample section located inside the channel S′ at a position farthest from the wall of the channel S′, its aperture 240a is the largest among all the openings 220, and on the other hand, as the sampling section 222b is the sample section located inside the channel S′ at a position nearest to the wall of the channel S′, its aperture 240b is the smallest among all the openings 220.

Since the sampling section 222b is disposed at a position relatively close to the pump, it will be subjected to a larger suction pressure comparing to the sampling section 222a which is disposed farther away from the pump. Therefore, by designing the opening 240a with larger aperture and the opening 240b with smaller aperture, the two openings 240a, 240b can allow the same amount of gaseous material to flow therethrough per unit time, and thus the gaseous material flowing in the channel S′ can be sampled uniformly.

Qualitatively, for any one opening 240 of the sampling pipe 200, the distance between an opening and the wall of the channel S′ is directly proportional to the aperture of such opening. That is, the farther an opening 240 is disposed away from the wall of the channel S′, the larger its aperture will be.

Furthermore, the size of the apertures of those openings can be defined quantitatively, which is realized by marking a marker R on the hollow body 220. The marker R is marked on the hollow body 220 at a position for enabling the distance between any one of the openings 240 and the marker R divided by the aperture of that opening to be a constant. In this embodiment, the marker R for identifying whether the sampling pipe is disposed correctly for sampling the channel aligned with the wall of the channel S′. However, it is not limited thereby and can be defined according to actual requirement.

From the above description, it is noted that since the sampling pipe 200 of the invention is configured with a plurality of openings 240 for enabling the same to sample gaseous materials flowing in different positions in the channel S′, the sampling result of the sampling pipe 200 may represent the whole truth of the actual situation in the channel S′.

To sum up, the sampling pipe 200 in this embodiment can ensure the flux of materials flowing into those sampling sections to be the same with each other by the use of those openings 240 with different apertures. Comparing with those conventional sampling pipes that the radioactivity measured from the gases sampled at the center of the channel S′ may be different from those sampled at a position near the pipe wall as the flowing speed of the gas flowing in the center of the channel S′ is faster than those flowing near the channel wall, the sampling result of the sampling pipe 200 of the invention will not be affected by the flowing speed regarding to where it is being sampled since it is designed with openings 240 of different apertures. Therefore, the sampling result of the sampling pipe 200 may represent the whole truth of the actual situation in the channel S′.

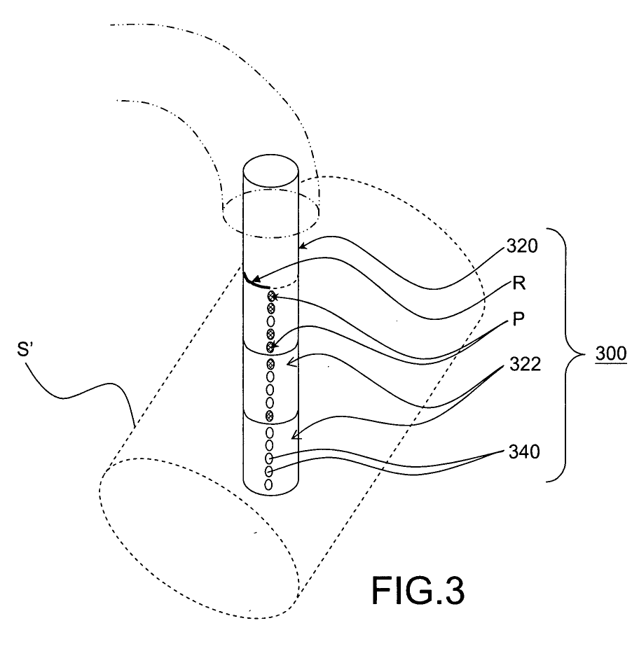

Please refer to FIG. 3, which shows a sampling pipe according to a second embodiment of the invention. The sampling pipe 300 shown in FIG. 3 is similar to the one 200 shown in FIG. 2 that it is also configured with a hollow body 320 and a plurality of openings 340. In this embodiment, the hollow body 320 is configured with a plurality of sampling sections 322, and the openings 340 are formed penetrating through the outer wall of the hollow body 320 and are disposed on the sampling sections 322 in a manner that each sample section 322 is formed with at least one of the plural openings 340. Moreover, the sampling sections 322 are adapted to be disposed inside the channel S′.

In the sampling pipe 300 shown in FIG. 3, there are more than one openings 340 to be formed on each sampling section 322 whereas the openings 340 in the same sampling section 322 are designed with the same aperture, in which the amount of the openings 340 formed on the sampling sections 322 disposed at positions near the wall of the channel S′ are fewer than those away from the wall of the channel S′.

For realizing the aforesaid design principle that the amount of the openings 340 formed on the sampling sections 322 disposed at positions near the wall of the channel S′ are fewer than those away from the wall of the channel S′, the sampling pipe 300 may first be designed with the same amount of openings 340 on each of its sampling sections 322, as the five openings shown in this embodiment, and then seal a portion of the openings 340 in its sampling sections 322 by the use of sealing parts with regard to the positions of where the sampling sections are adapted to be located in the channel S′. It is noted that the decision regarding to how many openings 340 are to be sealed is experimentally decided and is known to those skilled in the art so that it is not described further herein.

Similar to the sampling pipe 200 shown in the first embodiment, since the sampling pipe 300 in this embodiment is configured with a plurality of openings 340 for enabling the same to sample gaseous materials flowing in different positions in the channel S′, the sampling result of the sampling pipe 300 may represent the whole truth of the actual situation in the channel S′.

To sum up, the sampling pipe 300 in this embodiment can ensure the flux of materials flowing into those sampling sections 322 to be the same with each other by configuring different amount of openings 340 of the same aperture in different sampling sections 322. Comparing with those conventional sampling pipes that the radioactivity measured from the gases sampled at the center of the channel S′ may be different from those sampled at a position near the pipe wall as the flowing speed of the gas flowing in the center of the channel S′ is faster than those flowing near the channel wall, the sampling result of the sampling pipe 200 of the invention will not be affected by the flowing speed regarding to where it is being sampled since it is designed with openings 240 of different apertures. Therefore, the sampling result of the sampling pipe 200 may represent the whole truth of the actual situation in the channel S′.

From the above description, the sampling pipe of the invention has the following advantages:
(1) The sampling pipe of the invention is configured with a plurality of openings for enabling the same to sample gaseous materials flowing in different positions in the channel, the sampling result of the sampling pipe may represent the whole truth of the actual situation in the channel.
(2) The sampling pipe of the invention is capable of accurately measuring the radioactivity in a working environment since it can ensure the flux of materials flowing into those sampling sections to be the same with each other.
(3) Comparing with the prior-art technique that the accuracy of sampling a channel is improved by insetting more than one sampling pipe into the wall of the channel, the present invention can achieve the same or ever better accuracy by the use of only one sampling pipe so that the conventional airtightness problem in the channel is solved.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A sampling pipe suitable for sampling material in a channel, comprising:
a hollow body, having a plurality of sampling sections adapted to be disposed inside the channel; and
a plurality of openings, being disposed on the sampling sections while penetrating through the outer wall of the hollow body;
wherein, each sample section is formed with at least one of the plural openings for allowing the flux of materials flowing into those sampling sections to be the same with each other.

2. The sampling pipe of claim 1, wherein there is only one opening formed on each sampling section, and the apertures of the openings formed on different sampling sections are different from each other.

3. The sampling pipe of claim 2, wherein the apertures of the openings formed on the sampling sections disposed at positions near the channel's wall are smaller than those away from the wall of the channel.

4. The sampling pipe of claim 3, wherein the hollow body is configured with a marker for identifying whether the sampling pipe is disposed correctly for sampling the channel as soon as the marker is aligned with the wall of the channel, while the marker is located on the hollow body at a position thereof in a manner that, for any one opening of the sampling pipe, the distance between that opening and the marker divided by the aperture of that opening is a constant.

5. The sampling pipe of claim 1, wherein each of the sampling section of the sampling pipe has a plurality of openings formed thereat while enabling those openings formed on the same sampling section to have the same apertures.

6. The sampling pipe of claim 5, wherein the amount of the openings formed on the sampling sections disposed at positions near the wall of the channel are fewer than those away from the wall of the channel.

7. The sampling pipe of claim 6, wherein a portion of the plural openings is sealed by a plurality of sealing parts.

8. The sampling pipe of claim 1, being adapted for analyzing radioactive materials in the channel.

9. The sampling pipe of claim 1, wherein the channel is a ventilation pipe.

10. The sampling pipe of claim 1, wherein the channel is a drain pipe.
